(19) United States
(12) Patent Application Publication
(10) Pub. No.: US 2008/0289420 A1
(43) Pub. Date: Nov. 27, 2008

(54) Ultrasound Transducers

(75) Inventors: Alexander Cochran, Renfrewshire (GB); Katherine Kirk, Renfrewshire (GB); Chee Kin Lee, Renfrewshire (GB); Francis Placido, Renfrewshire (GB)

Correspondence Address: GOODWIN PROCTER LLP;PATENT ADMINISTRATOR, EXCHANGE PLACE, BOSTON, MA, 02109-2881, US

(73) Assignee: The University of Paisley, Paisley (GB)

(21) Appl. No.: 11/630,952

(22) PCT Filed: Jul. 1, 2005
(86) PCT No.: PCT/GB05/02571

§ 371 Date: May 20, 2008

(30) Foreign Application Priority Data
Jul. 1, 2004 (GB) 0414705.4

(51) Int. Cl. G01N 29/00; H04R 23/00

(52) U.S. Cl. 73/596; 381/150

(57) ABSTRACT

The invention relates to a thin film aluminium nitride ultrasound transducer, a method of manufacture the transducer and a test component upon which a thin film aluminium nitride ultrasound transducer is deposited. The aluminium nitride film may be (002) orientated with its c-axis normal to the surface of a substrate made of glass or a composite material. The invention also includes a system for non-destructive testing wherein a pulse is emitted from an ultrasound transducer to propagate through the test component and a reflected pulse is detected by the aluminium nitride thin film ultrasound transducer. The ultrasound transducer can be integrated into engine components such as bearings.

The present invention relates to the field of ultrasound transducers, and in particular to ultrasound transducers grown from thin films.

Ultrasound is used for investigating the interiors of opaque components where visual inspection is unsuitable. This may be where visual inspection is impossible or inadequate, or where important information can be obtained from ultrasound analysis. Piezoelectric transducers are used to generate and detect ultrasonic signals, with a pulse being directed into a component or material under investigation. A reflected signal, characterised by discontinuities in the component or material, is detected by transducers and is used to derive information on the discontinuities. These pulse-echo mode techniques are used for a variety of applications.

Conventionally, transducers are separate devices coupled to the test component or material. Effective acoustic coupling of the test component with the transducer presents a number of difficulties, resulting in a ultrasound pulses being inefficiently transmitted to the component. Waves reflected from the transducer-component interface impact on the detection of the reflected pulse. Typically, multilayer backing layers are required on the transducer to absorb unwanted reflections. This increases the size, weight, and material costs of the transducer unit. The shape of the transducer itself is also affected. The increased size, weight and cost, and effect on shape limits the practical applications of the transducers.

It would therefore be desirable to provide a transducer having improved coupling with a material or component to be investigated.

In addition, use of conventional transducers in high temperature systems requires complicated cooling or heat shielding arrangements. This increases the bulk of the transducers and increases capital costs, rendering them unsuitable for many applications. If coupling gel is necessary for effective acoustic coupling, the suitability for high temperature applications is further reduced, since the gel tends to solidify or evaporate when exposed to heat.

It would therefore be desirable to provide a transducer suitable for use in high temperature systems.

The market has an increasing demand for high frequency ultrasound transducers, capable of operating in the 50 to 300 MHz frequency range. Currently available high frequency transducers are expensive to produce and suffer from reliability problems.

It would therefore be desirable to provide an alternative ultrasound transducer with high frequency capabilities.

Polycrystalline aluminium nitride (AlN) thin films are known for their piezoelectric electric properties, and as such are used in thin film applications such as surface acoustic wave devices and resonators. AlN films can be deposited on substrates using a variety of deposition techniques, including RF-sputtering at low temperatures, as described in “Low temperature growth of RF reactively planar magnetron sputtered AlN films”, by M. Penza et al., Thin Solid Films, 259, (1995) pp. 154-162.

Various sputtering parameters affect the characteristics of the AlN films. “Condition monitoring with ultrasonic arrays at elevated temperatures” by K. Kirk et al, Insight Vol 45 No 2 Feb. 2003 discloses the deposition of AlN films by RF sputtering with no substrate heating. In a nitrogen atmosphere, the AlN film grows in the (002) orientation with the c-axis normal to the substrate surface, this orientation being preferred for some piezoelectric applications.

It is one aim of the invention to provide a thin film aluminium nitride ultrasound transducer and a method of manufacture thereof.

It is further aim of the invention to provide a test component having a thin film aluminium nitride ultrasound transducer deposited thereon.

It is further aim of the invention to provide a method for depositing a thin film aluminium nitride ultrasound transducer on a test component.

Further aims and objects of the invention will become apparent from reading the following description.

According to a first aspect of the invention, there is provided an ultrasound transducer comprising a thin film of aluminium nitride provided on a substrate.

Preferably, the aluminium nitride film is (002) orientated with its c-axis normal to the surface of the substrate.

The substrate may comprise metal. Alternatively, the substrate may comprise glass or a composite material.

More preferably, the substrate comprises a component of an apparatus of which ultrasound inspection is required.

The component may be a part of an engine.

The component may a bearing. The thin film of aluminium nitride may be deposited on the outer surface of the bearing.

Alternatively, the substrate is adapted to be coupled to an apparatus of which ultrasound inspection is required.

The thin film of aluminium nitride may be deposited on the substrate in a patterned arrangement.

Alternatively, the thin film of aluminium nitride may cover an entire surface of the substrate.

According to a second aspect of the invention, there is provided a system for non-destructive testing comprising a test component, an ultrasound transducer, ultrasound control apparatus and signal processing apparatus communicating with the ultrasound transducer, wherein a pulse is emitted from the ultrasound transducer to propagate the test component and a reflected pulse is detected by the ultrasound transducer, wherein the ultrasound transducer comprises a thin film of aluminium nitride deposited on the test component.

Preferably, the aluminium nitride film is (002) orientated with its c-axis normal to the surface of the substrate.

The component may be a part of an engine, or an assembly of parts of an engine.

The component may be a bearing assembly. The thin film of aluminium nitride may be deposited on the surface of a part of the bearing assembly. The surface may be a surface of a dust cap. Alternatively, the surface may be a surface of a raceway of a bearing.

The thin film of aluminium nitride may be deposited on the test component in a patterned arrangement.

Alternatively, the thin film of aluminium nitride may cover an entire surface of the test component.

The thin film of aluminium nitride may be provided with an electrode. The thin film of aluminium nitride may be provided with a plurality of electrodes.

The electrodes may be patterned such that an array of operable ultrasound transducers is defined.

According to a third aspect of the invention, there is provided a method of non-destructive testing a test component, comprising the steps of emitting a pulse from an ultrasound transducer to propagate in the test component and detecting a reflected pulse, wherein the transducer comprises a thin film of aluminium nitride deposited on the test component.

According to a fourth aspect of the invention, there is provided a component of a mechanical apparatus, wherein the component is provided with an ultrasound transducer formed from a thin film of aluminium nitride deposited on the component, and the transducer is adapted to emit or receive an ultrasound pulse into or from the component during ultrasound inspection.

Preferably, the aluminium nitride film is (002) orientated with its c-axis normal to the surface of the substrate.

Preferably, the component is a metal component.

Optionally, the component comprises two sub-components joined to one another at an interface, and the ultrasound transducer is adapted to direct an ultrasound pulse towards the interface.

Optionally, the component comprises two sub-components joined to one another at an interface, and the ultrasound transducer is adapted to receive an ultrasound pulse reflected from or transmitted through the interface.

The component may be a part of an engine.

The component may a bearing. The thin film of aluminium nitride may be deposited on the outer surface of a raceway of the bearing.

The thin film of aluminium nitride may be deposited on the component in a patterned arrangement.

Alternatively, the thin film of aluminium nitride may cover an entire surface of the component.

The system may be provided with an array of ultrasound transducers defined by a pattern of discrete areas of the aluminium nitride film.

Alternatively, an array of electrodes may be provided on a single area of the aluminium nitride film.

According to a fifth aspect of the invention there is provided a method of monitoring a bearing, the method comprising the step of emitting an ultrasound pulse from an ultrasound transducer, characterised in that the ultrasound transducer is formed from a thin film of aluminium nitride deposited on a part of the bearing.

According to a sixth aspect of the invention there is provided a method of ultrasonically imaging a test component, the method comprising the step of emitting pulses from an array ultrasound transducers formed from a thin film of aluminium nitride material deposited on the test component.

According to a seventh aspect of the invention there is provided a method of ultrasonically imaging a test component, the method comprising the step of detecting, using a receiving pulses from an array ultrasound transducers formed from a thin film of aluminium nitride material deposited on the test component.

According to an eighth aspect of the invention, there is provided a method of manufacturing an ultrasound transducer, the method comprising the step of depositing a thin film of AlN on a substrate.

Preferably, the step of depositing a thin film of AlN is carried out by RF-sputtering in a nitrogen atmosphere.

More preferably, the sputtering pressure is in the range of 650 to 950 kPa.

More preferably, the RF-power is approximately 800 W.

The present invention will now be described, by way of example only with reference to the following drawings, of which:

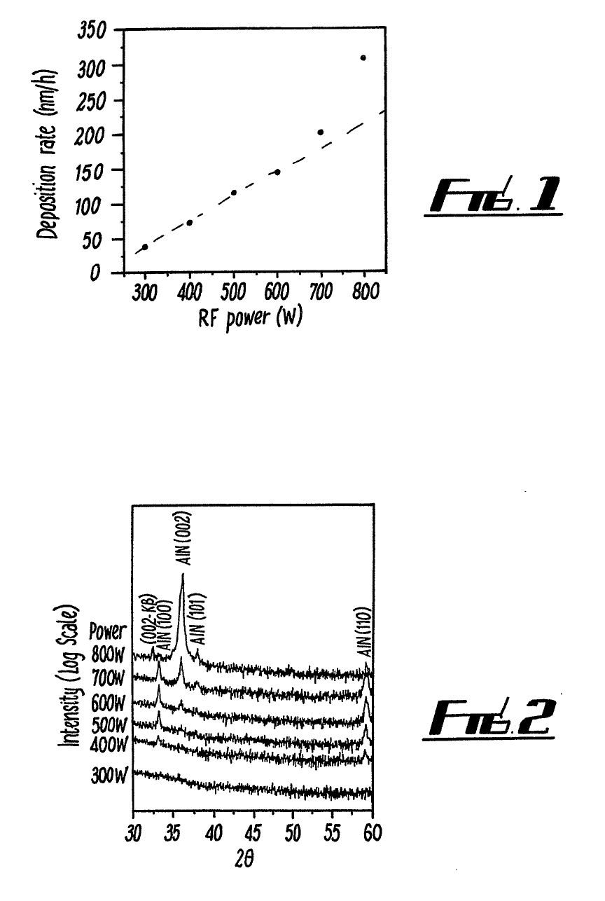

FIG. 1 is a graph of deposition rate of an AlN film versus RF-sputtering power;

FIG. 2 shows the crystallographic structure of an AlN film for different RF powers;

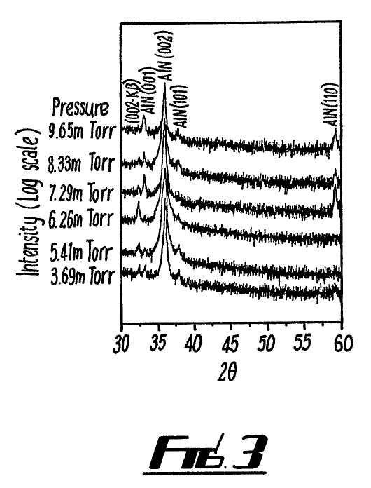

FIG. 3 shows the crystallographic structure of an AlN film for a range of sputtering pressures;

FIG. 4 shows the crystallographic structure of an AlN film for a range of ratios of Argon to Nitrogen process gas in the sputtering chamber;

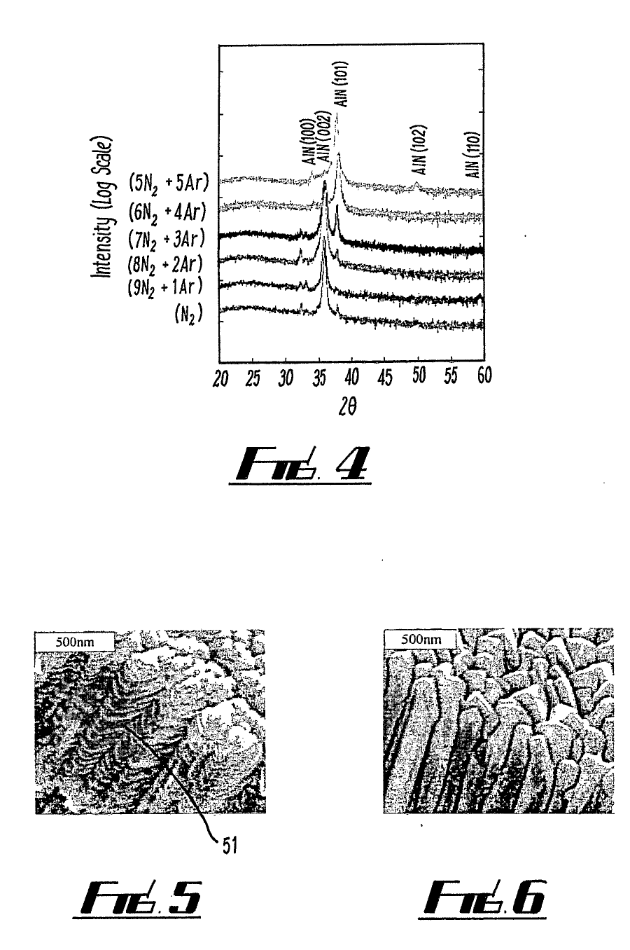

FIG. 5 is a scanning electron microscope image of a cross section of a (002) orientated AlN film for a pure nitrogen process gas;

FIG. 6 is a scanning electron microscope image of a cross section of a (002) orientated AlN film for a process gas with some argon:nitrogen ratio;

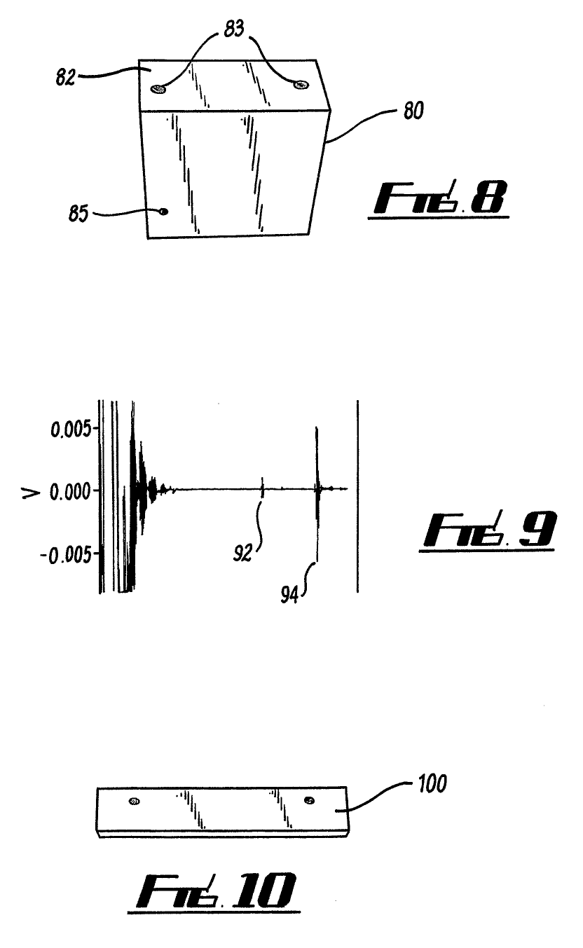

FIG. 7 shows piezoelectric data of an AlN film;

FIG. 8 is a perspective view of an aluminium block onto which an AlN film was deposited;

FIG. 9 shows the pulse-echo results for the block of FIG. 8;

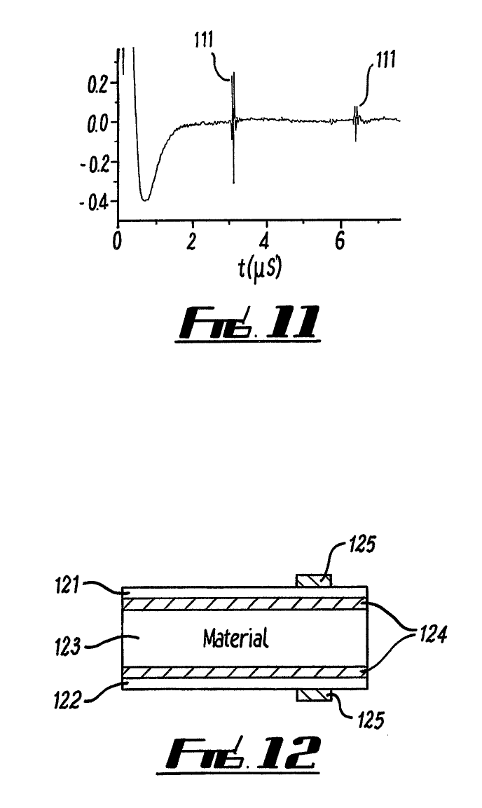

FIG. 10 is a perspective view of a mild steel block having an AlN film and electrodes deposited thereon, in accordance with an embodiment of the invention;

FIG. 11 shows the pulse-echo results for the block of FIG. 10;

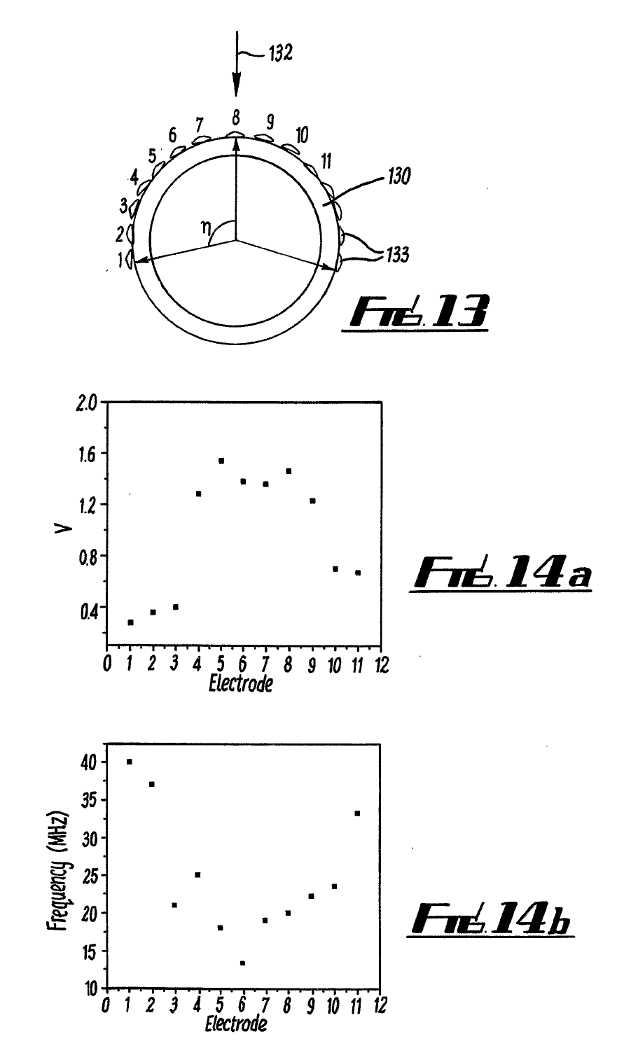

FIG. 12 shows schematically the use of a pair of AlN transducers in a through transmission mode;

FIG. 13 is a cross sectional view of an aluminium cylinder having an array of transducers formed thereon;

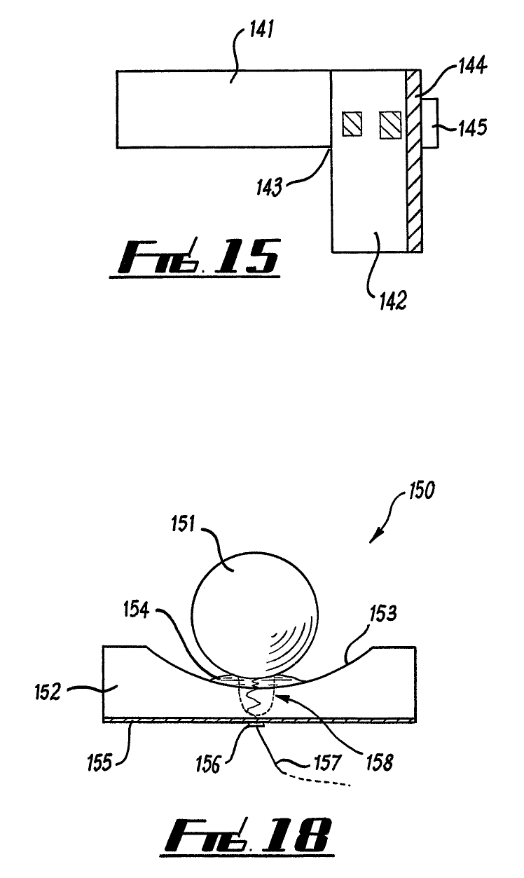

FIGS. 14a and 14b respectively show measurements of pulse amplitude and pulse frequency for the apparatus of FIG. 13;

FIG. 15 shows an example application of an embodiment of the invention to the monitoring of a join or weld in a mechanical component;

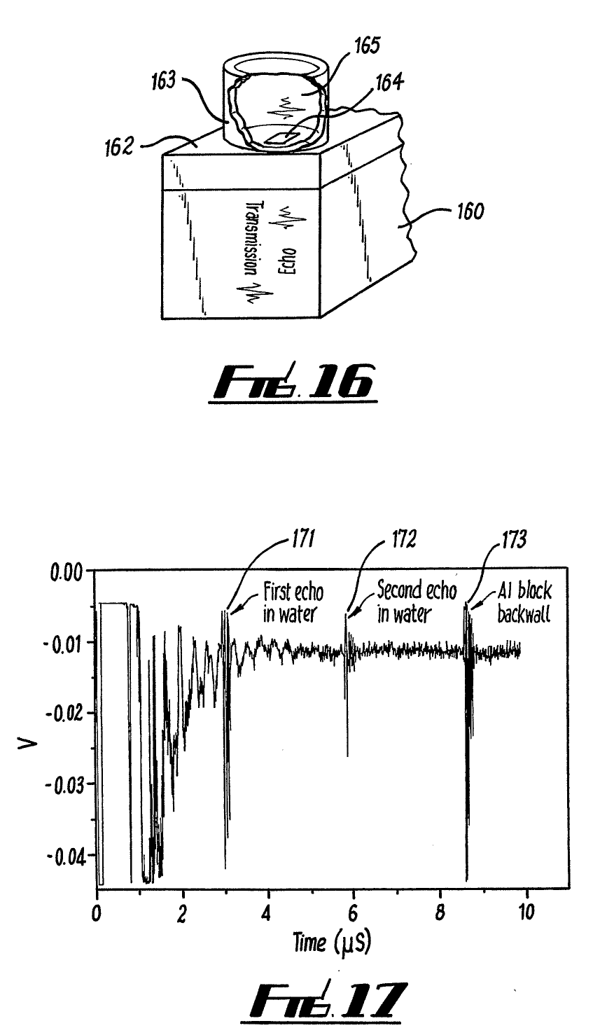

FIG. 16 shows an example application of an embodiment of the invention to fluid detection and fluid level measurement;

FIG. 17 shows detected pulses for the apparatus of FIG. 16;

FIG. 18 shows an example application of an embodiment of the invention to the monitoring of a bearing.

The present invention in its various aspects utilises the growth of thin films of AlN on various substrates. The following is an example of how such growth is achieved for a glass substrate.

A Cryo Vacuum Chamber (CVC) RF magnetron sputtering machine was used, with an aluminium target of 99.999% purity and a diameter of 20.3 cm (8 inches). The target to substrate distance was 24 cm.

The substrates were cleaned in an ultrasonic bath with isopropyl alcohol for 15 minutes to remove impurities on the substrate surface and to improve adhesion. The pressure in the chamber was reduced to around 10⁻⁶ Torr (˜10⁻⁴ Pa) using a cryo pump. Different sputtering conditions were applied, as described below. In each case, the target was pre-sputtered at the same deposition conditions for 10 minutes with the shutter closed in order to remove oxides present on the surface of the target. After opening the shutter, the AlN thin film was deposited for 7 hours with no substrate heating.

Three different sets of deposition conditions were investigated, as follows:
1. RF power was increased from 300 W to 800 W, with sputtering pressure maintained at around 5 mTorr (˜665 kPa) in a pure N₂ atmosphere.
2. Sputtering pressure was increased from 3.69 to 9.65 mTorr (˜492 to 1290 kPa) in a pure N₂ atmosphere, with RF power maintained at 800 W.
3. Adding Argon gas from 1 to 5 sccm, and reducing the flow of N₂ gas to maintain the total gas flow at 10 sccm, with sputtering pressure maintained at around 5 mTorr and RF power maintained at 800 W.

The deposition rate, defined as the film thickness divided by sputtering time, was measured for RF power from 300 W to 800 W. The results are shown in FIG. 1, as deposition rate (in nmh⁻¹) against RF power (in W).

The crystallographic structure of the film was determined using X-ray diffraction with a Siemens D5000 machine. FIG. 2 shows the crystallographic structure for different RF powers, and displays a strong (002) peak for a power of 800 W.

FIG. 3 shows the crystallographic structure for a range of sputtering pressures, and shows that the (002) peak is high for a range of sputtering pressures, and the presence of other peaks (for example, (110)) at the pressures used other than 6.26 mTorr (835 kPa).

FIG. 4 shows the crystallographic structure for a range of ratios of Argon to Nitrogen in the sputtering chamber. The results show a strong (002) peak for a pure N₂ atmosphere.

FIG. 5 is a scanning electron microscope image of a cross section of the films grown, obtained from a Hitachi S4100 SEM. The figure shows that the AlN film, which in this case is a (002) orientated film, grows in a columnar structure. The columns having tapered needle-shaped ends and display spirals 51 around the length of the columns. In contrast, no spiral layers are observed in FIG. 6, which is an image of a AlN film grown at a ratio of Argon to Nitrogen of 5:5, and having predominantly (101) orientation.

The experimental results show the optimal deposition conditions for deposition of a (002) AlN film to be an RF power of 800 W, in a pure N₂ atmosphere at about 6 mTorr (800 kPa).

However, it should be appreciated that optimal RF power can vary with the individual sputtering machine, and for extended deposition times additional orientations may become apparent, even under optimum conditions.

The above experimental results provide a deposition method for growing a highly (002) orientated AlN thin film with c-axis normal to the substrate surface.

The highly (002) orientated AlN thin films grown were investigated for piezoelectric activity using a Piezoelectric Force Microscope as follows. AlN was deposited on a layer of aluminium under the sputtering conditions described above, and a small Al contact was deposited on the upper surface of the AlN using a metal mask. FIG. 7 shows amplitude of piezoelectric displacement against applied voltage, used to calculate a value of the piezoelectric coefficient d₃₃ as 3.8 pm/V, demonstrating that the film has good piezoelectric properties.

The experimental data relates to a glass substrate, but the above techniques can be used to grow thin film AlN transducers on a variety of substrates, including metallic and crystalline substrates.

FIG. 8 shows an aluminium block 80 onto which an AlN film 82 was directly deposited. Electrodes 83 were painted on the film 82 and the block to form an ultrasonic transducer. The block was provided with a 1 mm hole 85 at a distance 20 mm from the upper surface. Pulse echo mode measurements were performed by exciting the AlN film in order to generate an ultrasound pulse which propagated in the block. Reflections of the pulse were detected by the transducer, with the results shown in FIG. 9. The figure clearly shows that an echo 94 from the lower surface of the block and an echo from the hole 92 have been detected by the AlN film.

FIG. 10 is a mild steel block 100 having an AlN film and electrodes deposited thereon. FIG. 11 shows the pulse-echo results for the block of FIG. 10, in which repeated reflections 111 from the lower surface of the block are observed.

FIG. 12 shows the use of the aluminium nitride thin film ultrasound transducer in a through transmission configuration. In this example, two AlN layers 121 and 122 are provided on opposite sides of a test sample 123. Aluminium layers 124 are provided between each AlN layer and the test sample. Silver paint electrodes 125 are provided on each layer, and one of the AlN layers is used as a transmitter, the other being a receiver.

No substrate heating is required for effective, reliable, reproducible results, enabling deposition on substrates for which other deposition techniques are unsuitable. In particular, the above-described techniques are suitable for growing highly (002) orientated AlN films on delicate and/or shaped substrates, or other components on which a uniform substrate temperature would be difficult to achieve.

The above-described techniques can also be used to deposit AlN thin films on curved surfaces. FIG. 13 shows in cross section an aluminium cylinder 130, onto which an AlN thin film has been deposited from one direction (shown by the arrow 132). An array of electrodes 133, some of which are numbered 1 to 11, was painted on the AlN thin film, and ultrasound was transmitted from an on-axis position (electrode position 8). The film was found to transmit ultrasound at off-axis angles greater than 45°. FIGS. 14a and 14b show amplitude and frequency measurements for individual transducers of the arrangement of FIG. 13. These results demonstrate that the described techniques are suitable for forming transducers on curved surfaces, allowing applications in the coating of bulk objects and test components.

The described method allows the production of effective ultrasonic thin film transducers. Transducers produced by this method offer the following benefits and advantages.

Deposition on a wide range of amorphous and crystalline substrates is possible, for example, glass, metal, and silicon.

No substrate heating is required for deposition, enabling the coating of bulk objects.

AlN is capable of withstanding high temperatures and is chemically stable.

Use of thin films makes it easy to achieve high frequency, and high bandwidth transducers. Transducers operational at frequencies of around 38 to 200 MHz are achievable.

The films are strongly crystalline and can be made several microns thick allowing increased energy generation by the material.

The surface of the blocks does not require extensive preparation, and good films have been made using only simple surface preparation techniques such as sandpapering or grinding, and surface cleaning by wiping with methanol using a lint-free cloth was sufficient.

A thin film grown on a component transfers ultrasound more efficiently to and from the component than a separate transducer, and avoids the need for backing materials to absorb unwanted reflections.

The thin film is low profile and does not add significant weight or bulk to the components, and thus is non-intrusive.

The AlN films have high electrical breakdown field, enabling larger transmitted power.

AlN has high acoustic velocity, and is lead free.

Instrumentation redesign is not required and good signal-to-noise ratios can be achieved.

Multilayers of AlN are possible, enabling design of transducers with advanced properties.

The above properties enable to the production of robust, inexpensive, high frequency transducers and arrays to replace conventional transducers. The AlN films can be grown on a support material, which is then attached in an appropriate manner to the material under investigation.

High frequency transducers and arrays can be used for example in layer thickness measurements in non-destructive testing and manufacturing control, and for high resolution real time acoustic microscopy.

The above-described technology has numerous additional applications. One application is in the field of non-destructive testing of important components, for example engineered metallic components or tools. In one implementation, a highly oriented AlN film is grown directly on a component to be tested to form an integrated ultrasonic transducer. Electrodes painted on the film define an array of ultrasound transducers capable of operation in conjunction with existing equipment.

Depending on the type of component, the sputtering process may need to be adapted in order to provide a satisfactory AlN film growth on the shaped component. For example, any directional sputtering and masking techniques known to one skilled in the art may be employed. The film can be deposited over the surface of the components to any extent required, or merely deposited in discrete patches.

The integrated transducer and test component improves acoustic coupling, and the thin film nature of the transducer does not add bulk or weight to the component, allowing it to perform its function.

In an alternative implementation, the film is deposited on a coupon, which is attached to a parent component to be monitored.

The foregoing has applications in, for example, monitoring the wear of precision components or high technology machine tools. In addition, engineering components under high stress or strain can be monitored for defects and flaws. Active condition monitoring of important components, such as brake components, parts in gearboxes, and critical regions of pipework in petrochemical processing plants can be achieved.

FIG. 15 shows an application of an aluminium nitride thin film transducer to the monitoring of a test component, which in this example is the monitoring of the integrity of metal joint or weld. FIG. 15 shows a pair of metal components 141 and 142 joined by a weld 143. Metal component 142 has a thin film of aluminium nitride 144 deposited thereon, with an electrode 145 formed on the thin film.

In use, the electrode excites the AlN film to cause an ultrasound pulse to propagate in the metal component 142. The pulse detected will be characterised by the integrity of the joint between the components 142 and 141, allowing detection of defects and flaws in the weld. The low profile and extremely good coupling of the AlN thin film transducers make them particularly suitable for this application.

It will be appreciated that pulse-echo, through transmission or acoustic emission and spectroscopic measurements could be used in this application. In some embodiments, the thin film may be formed in an array, and the test component may be imaged. In another embodiment, an array of electrodes may be formed on a continuous area of aluminium nitride thin film.

FIG. 16 shows schematically the application of an aluminium nitride thin film transducer to the detection of fluid. FIG. 16 shows an aluminium block 160 having an AlN film 162 deposited thereon. On an upper surface of the AlN film is a cavity or well 163, shown partially cut-away. An electrode 164 is positioned between the well 163 and the AlN thin film 162. When the AlN film is excited, an ultrasound pulse propagates in the metal block and any fluid 165 present in the well. FIG. 17 shows the results of a pulse-echo measurement using the apparatus of FIG. 16, and demonstrates that two echoes 171 and 172 corresponding to the presence of fluid in the cavity were detected, along with an echo 173 from the lower surface of the aluminium block. This configuration has applications in the detection of fluids accumulating on the surfaces of components, and measurement of fluid levels, for example in acoustic microscopy of biological specimens.

The present technology also has applications in the monitoring of oil films in bearings to check for the presence of cavities, discontinuities, drying out and breakdown of the oil film. At present, the investigation of oil films by ultrasound techniques is being researched using conventional transducers. The techniques described herein allow a thin film transducer to be grown on an outer surface of a bearing, thereby improving acoustic contact and avoiding the use of bulky and relatively heavy conventional transducers.

Activation of the outer surfaces of bearings allows monitoring of the internal oil film, giving the capability to identify lubrication problems and mitigate the risk of seizure. In particular, the reflected pulse will be characterised by the absence of an oil film adjacent the internal surface of the raceway.

FIG. 18 is a schematic representation of an application of the described techniques to the monitoring of oil films in bearings. FIG. 18 is a cross-sectional view through a bearing arrangement, generally depicted at 150. The Figure shows a ball bearing 151 in an outer section of a raceway 152. Located between the ball bearing 151 and the inner surface 153 of the raceway 152 is a quantity of lubricant 154, for example synthetic oil. To maintain the effective operation of the bearing, a sufficient quantity and quality of lubricant must remain between the ball bearing 151 and the raceway 152. Located on the outer surface of the raceway is an aluminium nitride thin film 155, deposited on the raceway by the RF sputtering techniques described above. The aluminium nitride thin film is provided with an electrode 156, connected to a pulser-receiver (not shown) by connector 157.

In use, the electrode activates the aluminium nitride thin film to generate an ultrasound pulse.158 that propagates first in the metal raceway 152, and then in the lubricant 154. The signal reflected from the interface between the ball bearing 151 and the lubricant 154 is characterised by the lubricant layer, allowing detection of cavities, discontinuities, drying out and breakdown of the lubricant film.

An aluminium nitride thin film ultrasound transducer is particularly suitable for this application due to its low profile, high temperature operation and broadband characteristics.

A yet further application of the technology is to process monitoring at high temperatures, for example in sintering powdered metals, monitoring green-state ceramic extrusion, and high frequency monitoring of colloid processing in the food industry.

Presently, there is significant unfulfilled demand for process monitoring at high temperatures. For example, there is very significant wastage in the food industry because of process variations that cause off-flavours and require the disposal of whole batches of food. The use of thin film AlN transducers produced in accordance with aspects of the present invention allows real-time physical analysis of textures, particle sizes and consistencies, to supplement chemical analyses.

Other applications result from the drive for miniaturisation, integration and cost-reduction in the sensor market and include:
acoustic microscopy
underwater sonar
biomedical imaging

The reproducible, reliable properties of the AlN transducers also renders then suitable for monitoring of the output of existing transducers.

Improvements and modifications may be incorporated herein without deviating from the scope of the invention.

1. An ultrasound transducer comprising:
a thin film of aluminium nitride provided on a substrate.

2. The ultrasound transducer of claim 1, wherein the aluminium nitride film is (002) orientated with its c-axis normal to the surface of the substrate.

3. The ultrasound transducer of claim 1, wherein the substrate is metal.

4. The ultrasound transducer of claim 1, wherein the substrate is glass or a composite material.

5. The ultrasound transducer of claim 1, wherein the substrate comprises a component of an apparatus of which ultrasound inspection is required.

6. The ultrasound transducer of claim 5, wherein the component is part of an engine.

7. The ultrasound transducer of claim 5, wherein the component is a bearing.

8. The ultrasound transducer of claim 7, wherein the thin film of aluminium nitride is deposited on the outer surface of the bearing.

9. The ultrasound transducer of claim 1, wherein the substrate is adapted to be coupled to an apparatus of which ultrasound inspection is required.

10. The apparatus of claim 1, wherein the thin film of aluminium nitride is deposited on the substrate in a patterned arrangement.

11. The apparatus of claim 1, wherein the thin film of aluminium nitride covers an entire surface of the substrate.

12. A system for non-destructive testing comprising:
a test component,
an ultrasound transducer, and
an ultrasound control apparatus and signal processing apparatus communicating with the ultrasound transducer,
wherein a pulse is emitted from the ultrasound transducer to propagate the test component and a reflected pulse is detected by the ultrasound transducer, and wherein the ultrasound transducer comprises a thin film of aluminium nitride deposited on the test component.

13. The system of claim 12, wherein the aluminium nitride film is (002) orientated with its c-axis normal to the surface of the substrate.

14. The system of claim 12, wherein the test component is a part of an engine, or an assembly of parts of an engine.

15. The system of claim 12, wherein the component is a bearing assembly.

16. The system of claim 15, wherein the thin film of aluminium nitride is deposited on the surface of a part of the bearing assembly.

17. The system of claim 16, wherein the surface is a surface of a dust cap.

18. The system of claim 16, wherein the surface is a surface of a raceway of a bearing.

19. The system of claim 12, wherein the thin film of aluminium nitride is deposited on the test component in a patterned arrangement.

20. The system of claim 12, wherein the thin film of aluminium nitride covers an entire surface of the test component.

21. The system of claim 12, wherein the thin film of aluminium nitride is provided with one or more electrode.

22. The system of claim 12, wherein the electrodes are patterned such that an array of operable ultrasound transducers is defined.

23. A method of non-destructive testing a test component, the method comprising the steps of
emitting a pulse from an ultrasound transducer to propagate in the test component and detecting a reflected pulse, wherein the transducer comprises a thin film of aluminium nitride deposited on the test component.

24. A component of a mechanical apparatus, comprising:
a component; and
an ultrasound transducer formed from a thin film of aluminium nitride deposited on the component, wherein the transducer is adapted to emit or receive an ultrasound pulse into or from the component during ultrasound inspection.

25. The component of claim 24, wherein the aluminium nitride film is (002) orientated with its c-axis normal to the surface of the substrate.

26. The component of claim 24, wherein the component is a metal component.

27. The component of claim 24, wherein the component comprises two sub-components joined to one another at an interface, and the ultrasound transducer is adapted to direct an ultrasound pulse towards the interface.

28. The component of claim 24, wherein the component comprises two sub-components joined to one another at an interface, and the ultrasound transducer is adapted to receive an ultrasound pulse reflected from or transmitted through the interface.

29. The component of claim 24, wherein the component is a part of an engine.

30. The component of claim 24, wherein the component is a bearing.

31. The component of claim 30, wherein the thin film of aluminium nitride is deposited on the outer surface of a raceway of the bearing.

32. The component of claim 24, wherein the thin film of aluminium nitride is deposited on the component in a patterned arrangement.

33. The component of claim 24, wherein the thin film of aluminium nitride covers an entire surface of the component.

34. The component of claim 24, further comprising an array of ultrasound transducers defined by a pattern of discrete areas of the aluminium nitride film.

35. The component of claim 24, further comprising an array of electrodes on a single area of the aluminium nitride film.

36. A method of monitoring a bearing, the method comprising the step of
emitting an ultrasound pulse from an ultrasound transducer, wherein the ultrasound transducer is formed from a thin film of aluminium nitride deposited on a part of the bearing.

37. A method of ultrasonically imaging a test component, the method comprising the step of
emitting pulses from an array ultrasound transducers formed from a thin film of aluminium nitride material deposited on the test component.

38. A method of ultrasonically imaging a test component, the method comprising the step of:
detecting, using one or more receiving pulses from an array of ultrasound transducers formed from a thin film of aluminium nitride material deposited on the test component.

39. A method of manufacturing an ultrasound transducer, the method comprising the step of
depositing a thin film of AlN on a substrate.

40. The method of claim 39, wherein the step of depositing a thin film of AlN is carried out by RF-sputtering in a nitrogen atmosphere.

41. The method of claim 40, wherein the sputtering pressure is in the range of 650 to 950 kPa.

42. The method of claim 41, wherein the RF-power is approximately 800 W.
